(19) United States
(12) Patent Application Publication
(10) Pub. No.: US 2018/0343938 A1
(43) Pub. Date: Dec. 6, 2018

(54) Anti-Fog Ventilating Face Masks

(71) Applicants: GEORGIA TECH RESEARCH CORPORATION, Atlanta, GA (US); Emory University, Atlanta, GA (US)

(72) Inventors: William John Koros, Atlanta, GA (US); Kuang Zhang, Atlanta, GA (US); Jill Morgan, Atlanta, GA (US)

(21) Appl. No.: 15/778,326

(22) PCT Filed: Nov. 23, 2016
(86) PCT No.: PCT/US2016/063489

§ 371 Date: May 23, 2018

Related U.S. Application Data
(60) Provisional application No. 62/258,703, filed on Nov. 23, 2015.

(51) Int. Cl. A41D 13/11; A62B 23/02

(52) U.S. Cl. CPC A41D 13/1115; A41D 13/1123; A41D 2400/20; A62B 23/025; A41D 13/1184

(57) ABSTRACT

Ventilating face masks and methods and systems for face mask ventilation are disclosed. In some embodiments, a mask ventilation system can comprise an expandable base layer comprising side edges and a ventilation layer external to the expandable base layer comprising side edges. When the expandable base layer is in an expanded state, the side edges of the ventilation layer and the side edges of the expandable base layer can define one or more ventilation gaps between the expandable base layer and the ventilation layer for diverting at least a portion of the wearer's breath away from the surface, wherein the diversion can decrease the relative humidity on the surface.

### CROSS-REFERENCE TO RELATED APPLICATIONS

This application, filed Nov. 23, 2016 claims the benefit of U.S. Provisional Patent Application Ser. No. 62/258,703, filed Nov. 23, 2015, entitled “Anti-Fog Ventilated Medical Face Mask,” the entire contents and substance of which are hereby incorporated by reference as if fully set forth below.

### TECHNICAL FIELD

The various embodiments of the disclosure relate generally to ventilating face masks and methods and systems for face mask ventilation. It is particularly useful for decreasing the relative humidity on a surface caused by a wearer's breath and thereby preventing fogging on the surface.

### BACKGROUND

Face masks generally are used to protect wearers from airborne hazards, such as infectious diseases, pollution, smoke, exhaust, or dust. Face masks are especially prevalent in the medical profession or in areas with a dense population or increased pollution levels. When used by medical professionals, face masks permit face-to-face communication between medical personnel and patients without risk of transferring infectious diseases. Conventional medical face masks typically have a plurality of layers including a melt-blown, filtration layer that can prevent the passage of water droplets through the mask when the wearer exhales.

For wearers in the medical profession, it is often desirable to wear a face shield in conjunction with a face mask to obtain additional protection, especially when treating patients with deadly infectious diseases, such as Ebola, HIV, AIDS, or Severe Acute Respiratory Syndrome. Such face shields can prevent contaminated fluids from entering a medical worker's eyes, nose, and oral cavity. One continuing problem attendant with the use of face shields in both medical and industrial applications is fogging of the shield. Fogging of a face shield occurs because exhaled air is typically warmer and moister than the surrounding air. Unfortunately, warm, moist air escaping from a face mask tends to condense on relatively cool surfaces close to the nose or mouth of the wearer. When worn in conjunction with a face shield, for example, such warm air can cause fogging on the face shield, and, consequently, impaired visibility. Fogging on the face shield of an operating room staff member, or of a surgeon is particularly undesirable and hazardous to a patient.

In the past, there have been several techniques that tried to solve this problem. For example, U.S. Pat. No. 4,037,593 shows a face mask with a vapor barrier for preventing clouding or fogging. While this prior mask might work, it has some definite drawbacks. U.S. Pat. No. 5,585,186 describes coating compositions that utilize an inorganic metal oxide in combination with silane or a siloxane oligomer to impart anti-reflection and anti-fog properties. Unfortunately, such techniques for reducing fogging are inadequate

### BRIEF SUMMARY

The various embodiments of the disclosure relate generally to ventilating face masks and methods and systems for face mask ventilation.

An embodiment of the disclosure can comprise a ventilating face mask. The ventilating face mask can comprise a base layer and a ventilation layer. The ventilation layer can be external to the base layer and can comprise a top edge attached to a top edge of the base layer and a bottom edge attached to the bottom edge of the base layer. Additionally the ventilating face mask can comprise one or more ventilation gaps formed between side edges of the base layer and side edges of the ventilation layer.

The ventilating face mask can comprise a medial width, a lateral width, a first gap depth, and a second gap depth. In some embodiments, the medial width can be greater than the lateral width and, in some embodiments, the first gap depth can be greater than the second gap depth. Additionally, the base layer can comprise two or more sub-layers and the ventilation layer can be composed of a permeable material.

An embodiment of the disclosure can comprise a mask ventilation system. The mask ventilation system can comprise a base layer having side edges and a ventilation layer overlaying the base layer and also having side edges. The side edges of the base layer and side edges of the ventilation layer define one or more ventilation gaps. Additionally, in some embodiments, the base layer can comprise a top edge and a bottom edge and the ventilation layer can comprise a top edge attached to the top edge of the base layer and a bottom edge attached to the bottom edge of the base layer. Embodiments of the mask ventilation system can comprise some or all of the features describe above with respect to the ventilating face mask.

Embodiments of the disclosure can also comprise a mask ventilation system for decreasing the relative humidity on a surface caused by a wearer's breath. The mask ventilation system can comprise an expandable base layer and a ventilation layer. The expandable base layer can have a top edge, a bottom edge, and side edges, and the ventilation layer can be external to the expandable base layer, comprise side edges, and have a top edge attached to the top edge of the expandable base layer and a bottom edge attached to the bottom edge of the expandable base layer. Additionally, the mask ventilation layer can have an expanded state and an unexpanded state, such that when in an expanded state, the side edges of the ventilation layer and the side edges of the expandable base layer can define one or more ventilation gaps between the expandable base layer and the ventilation layer. The ventilation gaps can divert at least a portion of the wearer's breath away from the surface, wherein the diversion decreases the relative humidity on the surface.

Embodiments of the mask ventilation system can decrease the relative humidity on a surface caused by a wearer's breath. The relative humidity can be measured about the surface when the surface is near the wearer's face. In some embodiments, the relative humidity can decrease by at least 25%, by at least 10%, or by at least 40%. Additionally, in some embodiments, the surface can be a face shield.

Embodiments of the mask ventilation layer can be expandable. In some embodiments, the expandable base layer can comprise pleating. Additionally, in some embodiments, the ventilation layer can be expandable, and can also comprise pleating. When in an unexpanded state, the expandable base layer can be defined by an unexpanded medial width and when in an expanded state the expandable base layer can be defined by an expanded medial width. In some embodiments, when in an expanded state, the expanded medial width can be greater than the unexpanded medial width. When in an expanded state, the base layer and the ventilation layer can be separated by a first gap depth and a second gap depth. In some embodiments, the first gap depth can be greater than the second gap depth. Additionally, when in an unexpanded state, the ventilation layer can be substantially flush with the base layer.

Embodiments of the disclosure can comprise a method for decreasing the relative humidity on a surface caused by a wearer's breath. The method can comprise: providing a first mask and layering a second mask over the first mask wherein the second mask is layered loosely such that one or more ventilation gaps form between the first mask and the second mask. The first and second masks can be placed on the wearer's face so as to substantially cover the mouth of the wearer and reduce the relative humidity near the surface. In some embodiments, the surface can be a face shield and the relative humidity can be decreased by at least 25%, at least 10%, or at least 40%. Additionally, in some embodiments, the first mask and the second mask can be separated by a first gap depth and a second gap depth. The first gap depth can be greater than the second gap depth.

Embodiments of the present disclosure can comprise another method for decreasing the relative humidity on a surface caused by a wearer's breath. The method can comprise providing a ventilating face mask, as described above, wherein when the ventilating face mask is placed on the wearer's face so as to substantially cover the wearer's nose and mouth, the relative humidity on the surface near the wearer's face can decrease. The ventilating face mask can comprise some or all of the features discussed above.

Embodiments of the present disclosure can comprise another method for decreasing the relative humidity caused by a wearer's breath and measured about a surface worn close to the wearer's face. The method can comprise providing an expandable ventilating face mask, as described above, expanding the expandable ventilating face mask to form one or more ventilation gaps between the side edges of the base layer and the side edges of the ventilation layer, placing the ventilating face mask on the wearer's face so as to substantially cover the nose and mouth of the wearer, and providing a surface near to the expandable ventilating face mask. When the wearer breathes, at least a portion of the wearer's breath can be diverted away from the surface and decrease the relative humidity on the surface. The method can comprise providing a ventilating face mask comprising some or all of the features discussed above.

### BRIEF DESCRIPTION OF THE DRAWINGS

FIGS. 1a and 1b show front and side views of a ventilating face mask having a ventilation layer in accordance with an exemplary embodiment of the present disclosure.

FIGS. 1c and 1d show front and side views of a ventilating face mask having a plurality of parameters in accordance with an exemplary embodiment of the present disclosure.

FIGS. 2a and 2b show a ventilating face mask in an expanded and an unexpanded state in accordance with an exemplary embodiment of the present disclosure.

FIGS. 3a-3d illustrate a ventilating face mask having a ventilation layer and worn in conjunction with a face shield in accordance with an exemplary embodiment of the present disclosure.

FIG. 4 illustrates the moisture content gradient between a face mask and a surface placed near the face mask in accordance with an exemplary embodiment of the present disclosure.

FIGS. 5a-5c illustrate a mask-over-mask configuration worn in conjunction with a face shield in accordance with an exemplary embodiment of the present disclosure.

FIG. 6 shows a psychrometric chart used in estimating various values relating to relative humidity in accordance with an exemplary embodiment of the present disclosure.

FIG. 7 illustrates an exemplary experimental set up for determining the decrease in relative humidity when wearing a mask-over-mask configuration in accordance with an exemplary embodiment of the present disclosure.

FIG. 8 illustrates an exemplary experimental set up for determining the decrease in relative humidity when wearing a face mask with a ventilation layer in accordance with an exemplary embodiment of the present disclosure

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another embodiment includes from the one particular value and/or to the other particular value.

By “comprising” or “having” or “including” is meant that at least the named element, component, structure, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Disclosed are various ventilating face masks and systems and methods for face mask ventilation. Aspects of the present disclosure can decrease the amount of condensation accumulating on a surface by decreasing the relative humidity on a surface caused by a wearer's breath. As used herein, relative humidity can refer to the amount of water vapor present in air expressed as a percentage of, or relative to, the amount of water vapor needed for saturation at a specific temperature. One problem when using, for example, medical face masks with a face shield, is fogging of the face shield. When the face shield is close to the nose or mouth of the wearer, the wearer's breath may pass through the face mask and cause condensation to form on the relatively cool surface of face shield. Such a phenomenon can occur on any surface close to a wearer's mouth or nose.

In an effort to develop masks that would reduce or eliminate issues with condensation on a nearby surface, several design efforts were attempted that applied different constructions or materials into a mask. However, each effort was problematic due to function, or costs, or both. For example, several masks were attempted that included a desiccant within the face mask to eliminate at least a portion of the water vapor. However, the masks became bulky and heavy, would ultimately cease functions, and carry an added cost associated with the materials. However, during the course of development, it was noted that a wearer having a heavy beard using a standard mask did not have the same rate of fogging as a person without a beard. This realization led to the surprising answer that diversion and not capture, sequestration, or elimination of the water vapor proved to be the answer. Thus, the disclosed ventilating face masks can reduce condensation by diverting the water vapor in exhaled air, rather than capturing or eliminating it.

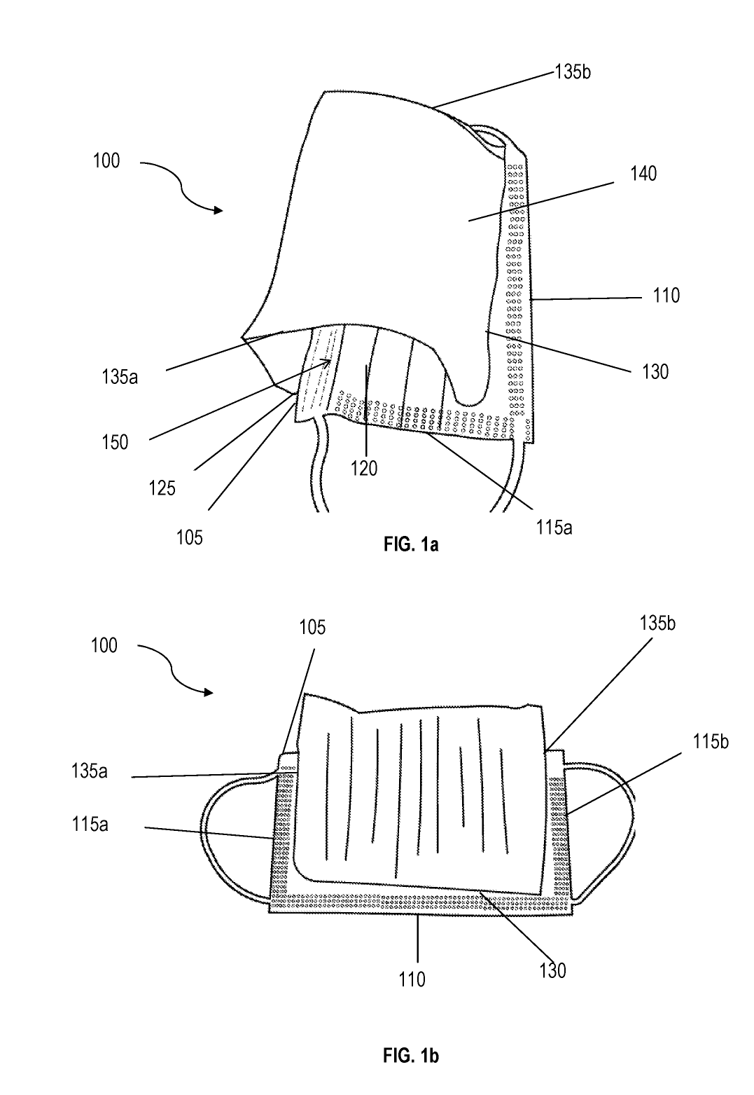

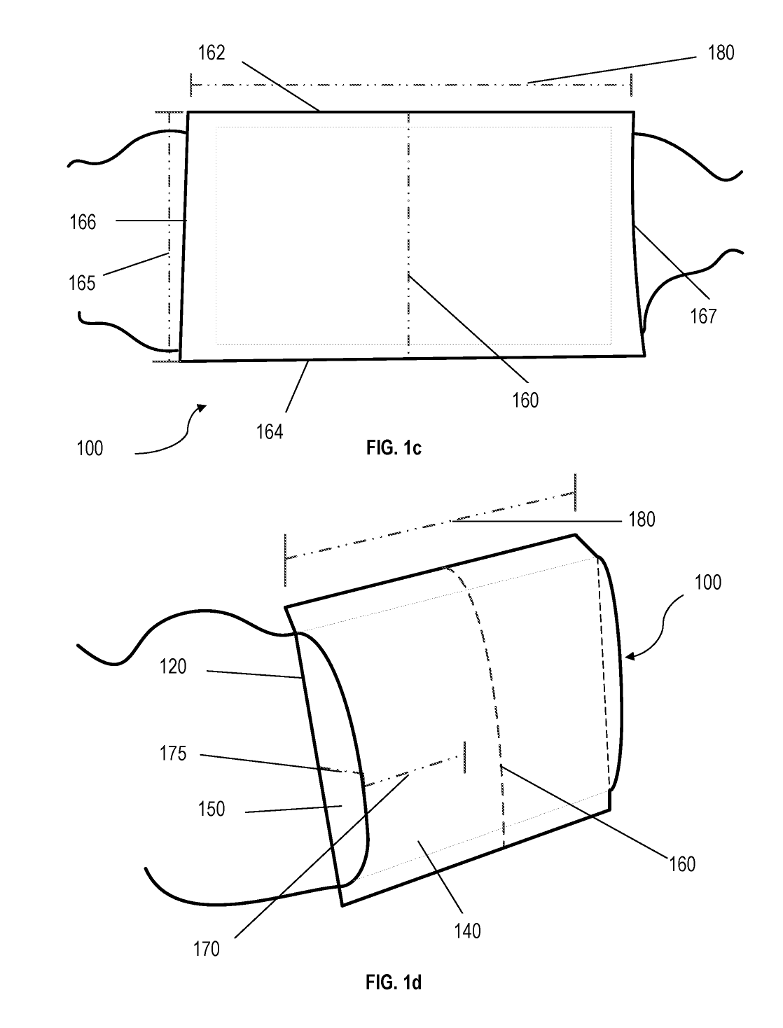

Disclosed are various ventilating face masks. FIGS. 1a and 1b illustrate an exemplary and non-limiting ventilating face mask, in accordance with an embodiment of the present disclosure. The ventilating face mask 100 can comprise a base layer 120 and a ventilation layer 140. The base layer 120 can have a top edge 105, a bottom edge 110, and side edges 115a, 115b. The ventilation layer 140 can be external to the base layer 120 and comprise a top edge 125, a bottom edge 130, and side edges 135a, 135b. In some embodiments, the ventilation layer 140 can be layered external to the base layer 120 and attach to the base layer 120 proximate the top 125 and bottom edges 130 of the ventilation layer. For instance, the top edge 125 of the ventilation layer 140 can be attached to the top edge 105 of the base layer 120, and the bottom edge 130 of the ventilation layer 140 can be attached to the bottom edge 110 of the base layer 120. When the base layer 120 and the ventilation layer 140 are attached together, one or more ventilation gaps 150 can be defined between the side edges 115a, 115b of the base layer 120 and the side edges 135a, 135b of the ventilation layer 140.

The top edge 105 of the base layer 120 can be attached to the top edge 125 of the ventilation layer 140, and the bottom edge 110 of the base layer 120 can be attached to the bottom edge 130 of ventilation layer 140. As used herein, “edge” can mean the outermost part or the part farthest away from the center of a component but need not be limited as such. “Edge” can also refer to a “portion” of a component, otherwise defined as a part or section surrounding the outermost part of the component or the part farthest away from the center of a component. Therefore, in a non-limiting example, “side edge” can also refer to “side portion,” “bottom edge” can also refer to “bottom portion,” and “top edge” can also refer to “top portion.”

The top edges 105,125 and bottom edges 110,140 of the base layer 120 and ventilation layer 140 can be attached together in a variety of different ways, depending on design preferences. In some embodiments, the ventilation layer may be bonded to base layer. For instance, in a non-limiting example, the top edges and bottom edges of the base layer and ventilation layer can be bonded together by conventional heat sealing and/or sonic bonding techniques. The ventilation layer can also be attached to the base layer by sewing together, gluing or adhesive, stapling, or otherwise physically attaching the layers together. Attachment along the top and bottom edges of the ventilation layer can substantially prevent moisture and/or vapor from escaping the ventilating face mask by flowing upwardly or downwardly and thereby Rigging the face shield when the wearer exhales. In an exemplary, and non-limiting embodiment, and as illustrated at FIG. 1a, the side edges 135a,135b of the ventilation layer are not attached with the side edges 115a,115b base layer, thus air can be ventilated undisturbed through the ventilation gaps 150 as the wearer breathes.

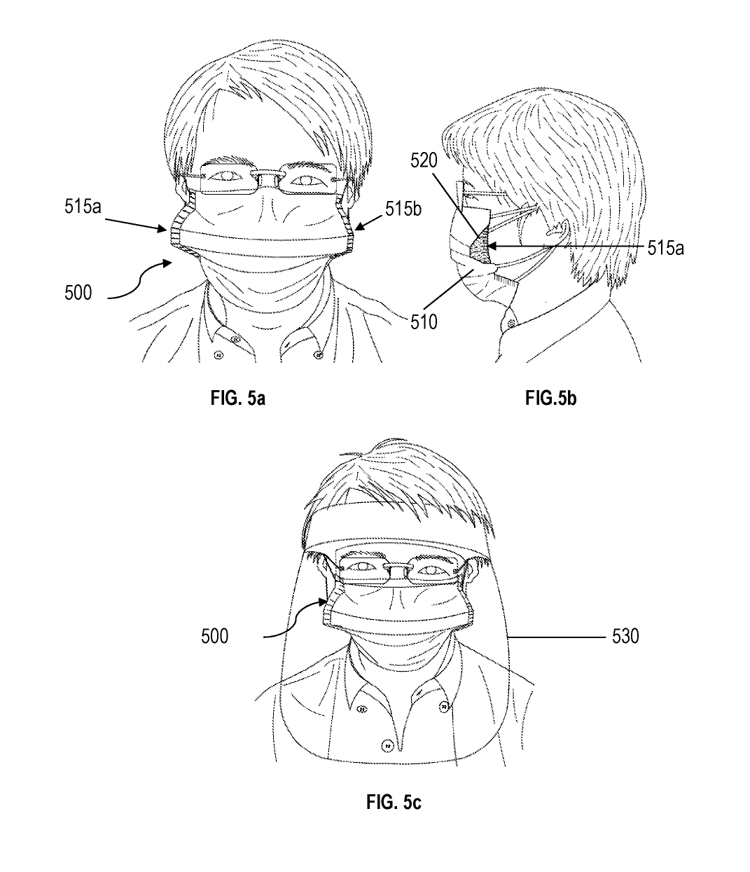

In some embodiments, the ventilation layer and the base layer are not attached at all. For instance, the base layer may comprise a first mask, and the ventilation layer may comprise a second mask, wherein the second mask is layered loosely, or otherwise overlays, the first mask. Such a configuration will be described in greater detail with respect to FIGS. 5a-5c.

The ventilating face mask 100 can be defined by a variety of parameters that can be adjusted as desired, based on design preferences, as illustrated at FIGS. 1c and 1d. For instance, the ventilating face mask 100 may be defined by a medial width 160, a lateral width 165, a gap length 170, a gap depth 175, and a mask length 180. One or more of the preceding parameters may be measured about a surface of the ventilating face mask. As will be understood, the surface may straight, arced, flat, or otherwise uneven. The medial width 160 can comprise a distance measured along a surface of the ventilating face mask 100 from about a top edge 162 to about a bottom edge 164 and proximate a center portion. The lateral width 165 can comprise a distance measured along a surface of the ventilating face mask 100 from about a top edge 162 to about a bottom edge 164 and proximate a side edge 166. The gap length 170 can be measured along the surface of the ventilating face mask 100 from about a first end of a ventilation gap 150 to about a second end of the ventilation gap 150. The gap depth 175 can comprise a linear distance measured from about a surface of the ventilation layer 140 to about a surface of the base layer 120. The mask length 180 can comprise a linear distance measured between the two side edges 166, 167 of the ventilating face mask 100.

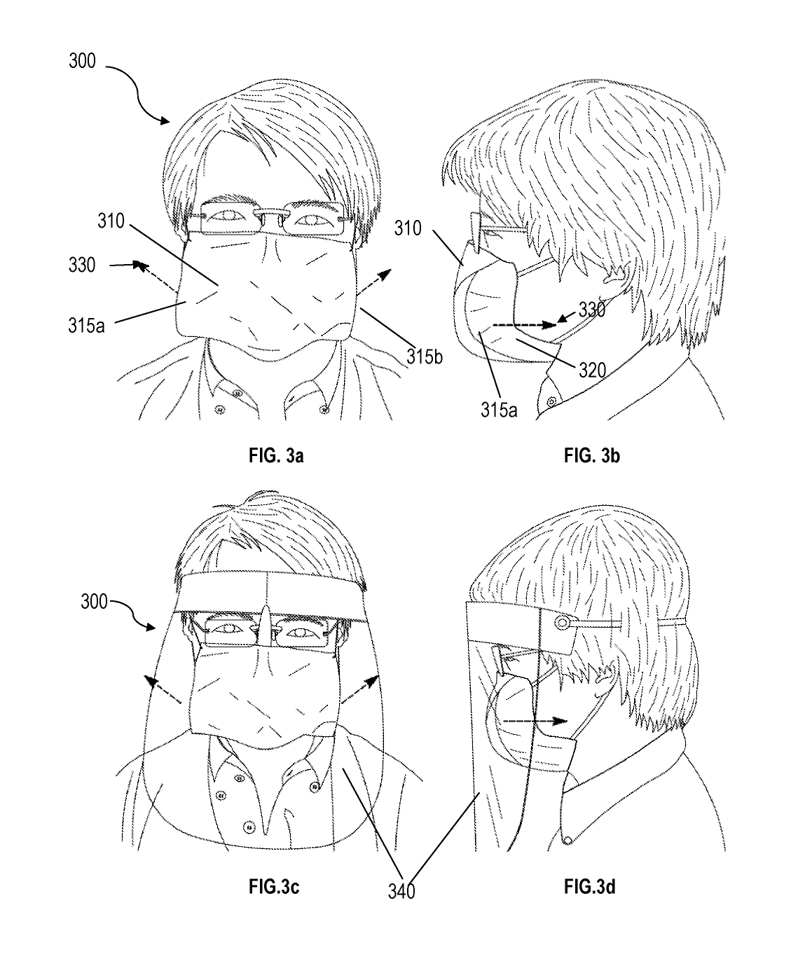

As illustrated at FIG. 1a, the ventilating face mask 100 can comprise one or more ventilation gaps 150 formed between the separated side edges of the base 115a, 115b and ventilation layers 135a, 135b. Each ventilation gap 150 can comprise a space or opening formed between the separated side edges (i.e. side portions) of the base 120 and ventilation 140 layers. In an exemplary and non-limiting embodiment, the ventilation layer can comprise two ventilation gaps, one on either side of the ventilating face mask. The two ventilation gaps may be the same size, but need not be. In some embodiments, the ventilating face mask may comprise four ventilation gaps, two on each side of the ventilating face mask. When the ventilating face mask is worn by a wearer, the ventilation gaps can divert the wearer's breath away from the face shield. This diversion will be discussed in further detail below with respect to FIGS. 3a-3d.

The ventilation gaps can be defined by a gap length 170, as illustrated at FIGS. 1c and 1d. For instance, as discussed above, the gap length 170 can comprise a linear distance from about a first end of a ventilation gap to about a second end of the ventilation gap. The first end of the ventilation gap may comprise the outermost portion of the ventilation gap when defined by a side edge of the ventilation layer and a side edge of the base layer. The second end may be a point where the ventilation gap terminates. The ventilation gap may terminate, for instance, when a portion of the ventilation layer and a portion of the base layer are substantially flush. In other embodiments, the ventilation gap may extend across the entire ventilating face mask from about a first side edge to about a second side edge of the ventilating face mask.

The gap length 170 can be defined as a percentage of the mask length 180, or the linear distance between the two side edges 166, 167 of the ventilating face mask 100. In some embodiments, the gap length can be about 100% the mask length. In some embodiments, the gap length can be about 25%, about 30%, about 50%, or about 75% of the mask length. In some embodiments the gap length can be less than about 50% of the mask length. In some embodiments the gap length can be less than about 30% of the mask length. In an embodiment where the ventilating face mask comprises two ventilation gaps, one on each side of the ventilating face mask, the ventilation gaps may have the same gap length or different gap lengths, depending on design preferences.

The ventilation gaps may also be defined by a gap depth 175, as discussed above with respect to FIGS. 1c and 1d. In some embodiments the base layer and the ventilation layer can be separated by a first gap depth and a second gap depth. The first gap depth can be a different size than the second gap depth. For instance, in a non-limiting example, the first gap depth can be larger than the second gap depth. In an embodiment wherein each ventilation gap comprises two gap depths of a different size, the ventilation gaps may be tapered such that the ventilation gap has the greatest gap depth proximate an outermost edge of the ventilating face mask and the gap depth decreases as the ventilation gap gets closer to a central portion of the ventilating face mask. In some embodiments, the first gap depth is about 5%, about 10%, about 25%, about 50%, about 75%, or about 90% larger than the second gap depth. The first gap depth can be at least about 5%, at least about 25%, at least about 50%, at least about 75%, or at least about 90% larger than the second gap depth.

The ventilating face mask may comprise a medial width 160 and a lateral width 165, as discussed above with respect to FIGS. 1c and 1d. The medial width 160 and the lateral width 165 can be increased or decreased as desired, based on design preferences. In some embodiments, the medial width can be greater than the lateral width, but need not be. The medial width can be about 5%, about 10%, about 25%, about 30%, about 50%, about 75%, or about 90% larger than the lateral width. The medial width can be at least about 5%, at least about 25%, at least about 50%, at least about 75%, or at least about 90% larger than the lateral width. In some embodiments, the medial width and the lateral width can be approximately equivalent.

The ventilation layer and the base layer of the ventilating face mask can have various structures and can be made of various materials. In some embodiments, the base layer can be a face mask portion comprising two or more sub-layers, including a filtration layer and one or more non-woven layers, and elastic bands for attaching the mask around a wearer's ears. For instance, the face mask portion may comprise three sub-layers including a filtration layer housed between two non-woven layers. In some embodiments, the filtration layer can be composed of any material that can act as a filter to prevent airborne hazards from entering or exiting the filtration layer. In an exemplary and non-limiting embodiment, the filtration layer can be composed of melt-blown polypropylene.

The ventilation layer can be composed of a single layer of material. However it is also contemplated that the ventilation layer can comprise two or more sub-layers. In an exemplary and non-limiting embodiment, the ventilation layer can be composed of a single filtration layer, as disclosed above. The ventilation layer can therefore also act as a filter to stop airborne hazards from entering or exiting the ventilation layer. For example, and not limitation, the ventilation layer may be composed of a permeable material, such as melt-blown polypropylene. Permeable materials can be advantageous at least because the outer layer will not substantially hinder a wearer's breathing. As will be understood, the ventilation layer can be composed of a permeable material or a non-permeable material. In embodiments where the ventilation layer may be composed of a non-permeable material, the ventilation layer may be formed from a wide variety of thin film plastic sheets, including sheets composed of polyethylene, polypropylene, polyvinyl chloride, or polyvinyl acetate.

In some embodiments, both the ventilation layer and the base layer can be generally rectangular in shape, as illustrated at FIGS. 1a and 1b. However, the shape of the ventilation layer and the base layer can be altered as desired, and in some embodiments, can be square, oval, or circular, depending on design preferences. Additionally, the ventilation layer and the base layer need not have the same shape and size. While in some embodiments, the width of the base layer, as measured between its top edge and bottom edge, is approximately equal to or greater than the width of ventilation layer, as measured between its top edge and bottom edge. Thus, the ventilation layer can be placed in juxtaposition with the base layer, or a portion of the base layer. Additionally, the length of the corresponding side edges of the ventilation layer can be less than or equal to the length of the respective side edges of the base layer.

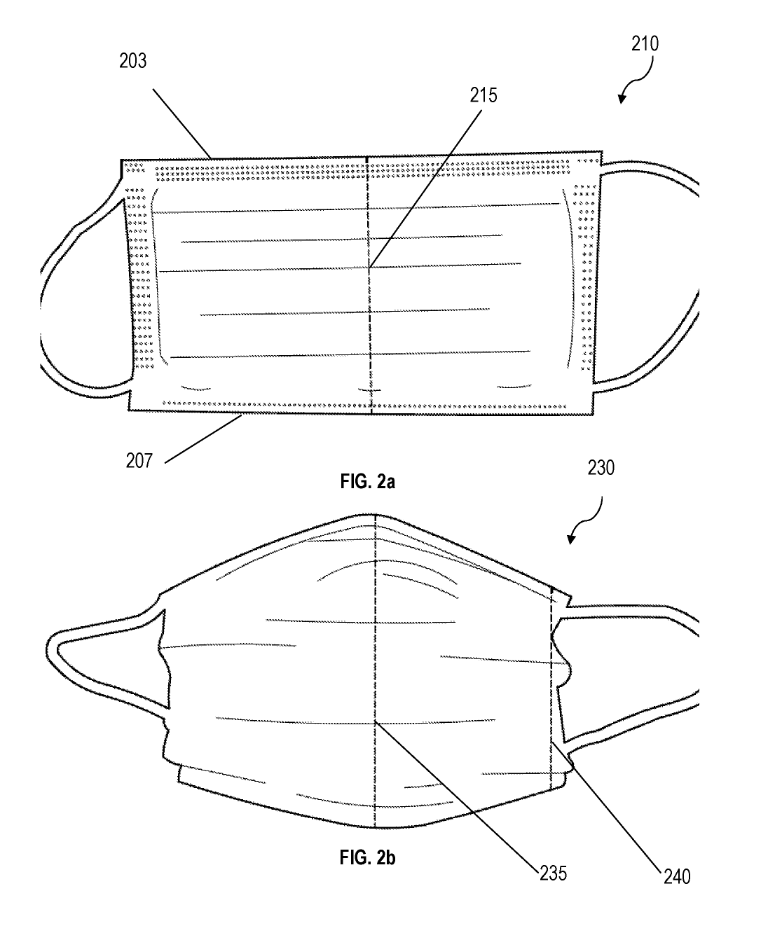

In some embodiments, the ventilating face mask may be expandable so as to substantially cover the nose and mouth of a wearer. FIGS. 2a and 2b illustrate a ventilating face mask in an unexpanded 210 and an expanded 230 state, respectively. When in an unexpanded state 210, as illustrated at FIG. 2a, the ventilation layer can lay substantially flush to the base layer, and the ventilating face mask can be defined by an unexpanded medial width 215. Subject to a force applied to one or both of the top edge 203 and the bottom edge 207 of the ventilating face mask, the ventilating face mask can be expanded, as illustrated at FIG. 2b. In some embodiments, the expansion of the ventilating face mask can cause one or more ventilation gaps to form between the side edges of the ventilation layer and the side edges of the base layer. When in an expanded state 230, the ventilating face mask can be defined by an expanded medial width 235. As will be understood, the expanded medial width 235 can be greater than the unexpanded medial width 215. Additionally, when in an expanded state 230, the ventilation layer can have a medial width 235 that is greater than a lateral width 240.

When in an expanded state 230, the expanded medial width 235 can be greater than the unexpanded medial width 215. As discussed above with respect to FIGS. 1c and 1d, expanded and unexpanded medial widths can comprise a distance measured along a surface of the ventilating face mask from about the top edge to about the bottom edge and proximate a center portion. The size increase of the ventilation layer due to expansion can be defined as the percent increase in size between the unexpanded medial width and the expanded medial width. In some embodiments, the expanded medial width can be about 5%, about 10%, about 20%, about 50%, about 75%, or even about 100% greater than the unexpanded medial width. In some embodiments, the expanded medial width can be at least about 5%, at least about 10%, at least about 20%, at least about 30%, at least about 50%, at least about 75%.

Certain structural elements of the ventilating face mask can allow the ventilating face mask to expand. Both the ventilation layer and the base layer may be expandable, according to some embodiments. For instance, in an exemplary and non-limiting embodiment, the base layer of the ventilating face mask may comprise pleating, as illustrated at FIG. 1a. In some embodiments, the base layer may comprise at least 3 pleats. In some embodiments, the base layer may comprise 3 pleats, 4 pleats, or 5 pleats. Still in other embodiments, the base layer may comprise more than 5 pleats. Additionally, the ventilation layer may comprise pleating. For instance, the ventilation layer may comprise the same number of pleats as the base layer, but need not. As used herein, the number of pleats is determined by the number of folds in the material.

In view of the ventilating face masks described above, embodiment of the ventilating face mask can comprise a mask ventilation system 300 for decreasing the relative humidity on a surface caused by a wearer's breath, as illustrated at FIGS. 3a-3d. The mask ventilation system 300 can comprise an expandable ventilation layer 310 external to the base layer 320. As discussed above, the expandable base layer 320 can have a top edge, a bottom edge, and side edges, and the ventilation layer 310 can also have a top edge, a bottom edge, and side edges. The top edge of the ventilation layer can be attached to the top edge of the expandable base layer, and the bottom edge of the ventilation layer can be attached to the bottom edge of the expandable base layer. The base layer 320 can be expandable and therefore cause the mask ventilation system 300 to have an expanded state and an unexpanded state, as described previously. When in an expanded state, and as illustrated at FIGS. 3a and 3b, the mask ventilation system 300 can substantially cover the nose and mouth of a wearer. Additionally, in some embodiments, the ventilation layer 310 can be expandable and work in conjunction with the expandable base layer 320 to cause the mask ventilation system to have an expanded state and an unexpanded state.

When in an expanded state, the side edges of the ventilation layer 310 and the side edges of the expandable base layer 320 can define one or more ventilation gaps 315a,315b between the expandable base layer 320 and the ventilation layer 310. The one or more ventilation gaps 315a,315b can be advantageous because they can divert at least a portion of the exhaled air away from the surface, thereby decreasing the relative humidity on the surface. FIGS. 3a-3d illustrate a mask ventilation system 300 where air is diverted 330 out the ventilation gaps 315a,315b. FIGS. 3c and 3d illustrate air being diverted away from a surface 340, for example, a face shield. The mask ventilation system 300 can comprise some or all of the features discussed above with respect to the ventilating face mask.

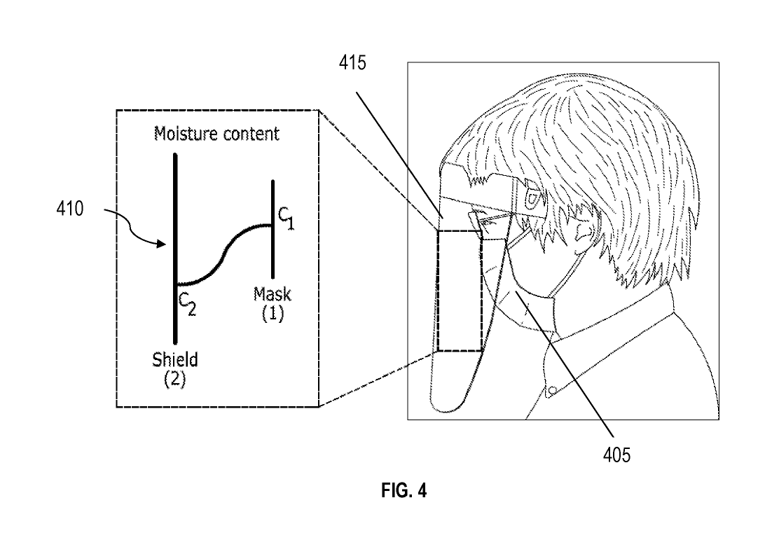

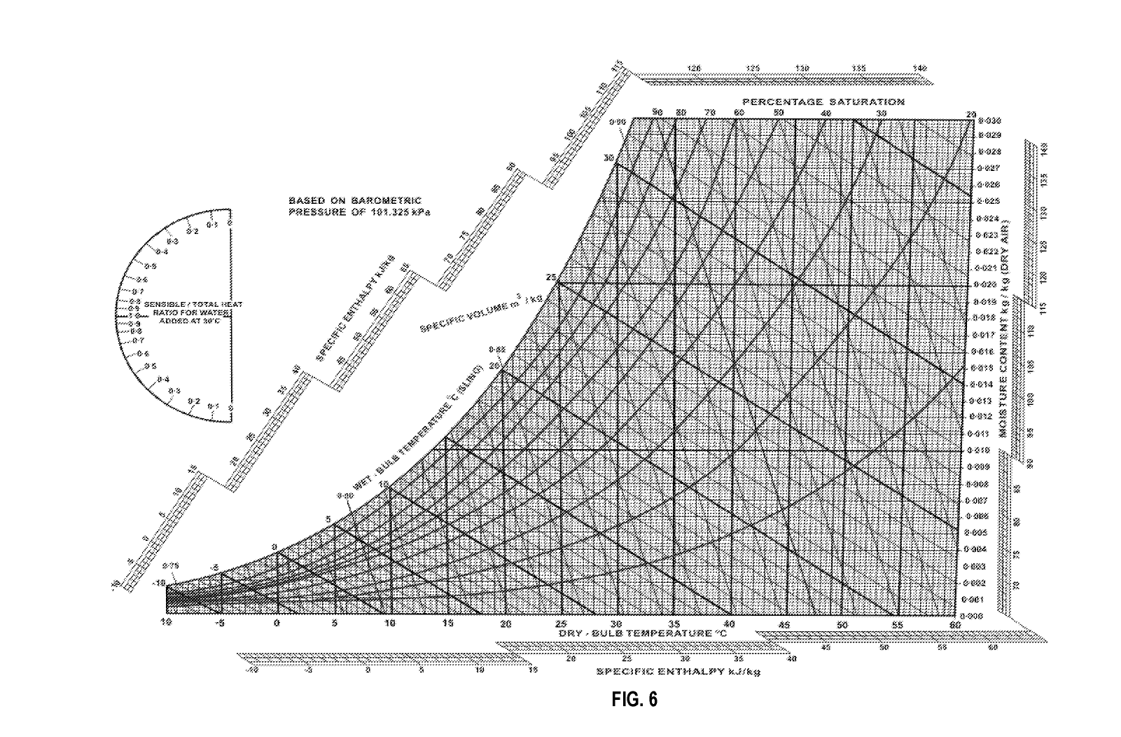

The disclosed mask ventilation system 300 can decrease the relative humidity on a surface 340. When worn near a surface, such as a face shield or eyeglasses, known face masks have no mechanism for decreasing fogging on the surface, or at least are deficient in performing the same. Thus, the wearer's exhaled air can cause fogging on a surface which may result in unsafe conditions for the wearer or another person, such as a patient, or may discourage the wearing of the protective equipment, or may discourage compliance with safety protocols. Fogging on a surface can occur when a wearer's exhaled air is warmer than the air surrounding the wearer. For example, at room temperature (i.e. 25° C.), fogging on a surface can occur because the relative humidity is 100% in the wearer's mouth, and the temperature of the exhaled air in the face mask is 37° C. In such an example, the moisture content of the exhaled air in the face mask is therefore 0.04 kg/kg dry air. The temperature of the face shield, on the other hand, is room temperature, i.e. 25° C. At 25° C., the moisture content of 100% relative humidity is 0.02 kg/kg dry air. Therefore, between a face mask 405 and a face shield 415, there is a moisture content gradient 410, as shown in FIG. 4. The moisture content gradient 410 can be defined by a first moisture content (C1), measured at the face mask, and a second moisture content (C2), measured at the face shield. When the moisture content of air on the surface of face shield is equal to or greater than 0.02 kg/kg dry air, water vapor condenses on the face shield. When the moisture content of air on the surface of face shield is smaller than 0.02 kg/kg dry air, water vapor does not condense on the face shield and fogging does not occur. The relative humidity about a surface in varying environments can be understood in greater detail with regard to the psychrometric chart illustrated at FIG. 6, which illustrates the thermodynamic parameters of moist air such as percentage saturation, moisture content, temperature, and specific enthalpy at a constant pressure. Psychrometric charts are standard engineering diagrams known to those of skill in the art for evaluating air moisture and humidity, among other characteristics. Examples can be found in any advanced engineering text, such as Perry's Chemical Engineers' Handbook.

The additional ventilation layer 310 can define one or more ventilation gaps 315a,315b between the ventilation layer 310 and the base layer 320. When a wearer breathes, at least a portion of the exhaled air will vent out 330 of the ventilation gaps, as illustrated at FIGS. 3a-3d, thereby decreasing the relative humidity about a surface. The relative humidity can be measured about a surface when the surface is near the wearer's face. In some embodiments, “near a surface” can comprise a distance of at least about 0.5 inches, at least about 1 include, at least about 2 inches, at least about 5 inches, or at least about 8 inches. In some embodiments, the relative humidity about the surface can be decreased by at least about 10%, at least about 25%, at least about 40%, at least about 50%, or at least about 60%. In some embodiments, the relative humidity about the surface can be decreased by about 10%, about 30%, about 50%, or about 60%.

The mask ventilation system can decrease the relative humidity proximate a surface. In some embodiments, as illustrated at FIGS. 3c and 3d, the surface may comprise a medical face shield 340 or a pair of eye-glasses. Still the face mask can decrease the relative humidity about a variety of surfaces including, but not limited to, sunglasses, goggles, mirrors, windows, motorcycle helmet face shields, or screens of an electronic device, such as a smart phone lap top, or tablets.

In view of the ventilating face masks and systems for mask ventilation discussed above, embodiments of the present disclosure can comprise a method for decreasing the relative humidity on a surface 530 caused by a wearer's breath, the method comprising a mask over mask configuration 500, as illustrated at FIGS. 5a-5c. As such, the method can comprise providing a first mask and layering a second mask over the first mask. For instance, the second mask can 510 be layered loosely over the first mask 520 such that one or more ventilation gaps 515a,515b can form between the first mask 520 and the second mask 510. The method can further comprise placing the layered first and second masks 500 on a wearer's face so as to substantially cover the nose and mouth of the wearer, as illustrated at FIGS. 5a-5c. Worn as such, the layered first mask and second mask can reduce the relative humidity near a surface.

The method can comprise layering a second mask 510 loosely over a first mask 520. The disclosed methods can further comprise wearing the first mask over a portion of the wearer's nose, the wearer's mouth, and the wearer's chin. Additionally, the method can comprise layering the second mask over the wearer's mouth and a portion of the wearer's nose but not over the wearer's chin. As such, the second mask can form one or more ventilation gaps 515a,515b, as described above.

As discussed above, the method can reduce the relative humidity about a surface 530. The surface can be a face shield or eye-glasses, or another type of surface, as discussed above. The relative humidity can be measured about a surface when the surface is near the wearer's face. In some embodiments, “near a surface” can comprise a distance of at least about 0.5 inches, at least about 1 include, at least about 2 inches, at least about 5 inches, or at least about 8 inches. As discussed above, in some embodiments, the relative humidity about the surface can be decreased by at least about 10%, at least about 25%, at least about 40%, at least about 50%, or at least about 60%. In some embodiments, the relative humidity about the surface can be decreased by about 10%, about 30%, about 50%, or about 60%.

Additionally, the first mask 520 and the second mask 510 can be separated by a first gap depth and a second gap depth, as discussed above. The first gap depth can be a different size than the second gap depth. For instance, in a non-limiting example, the first gap depth can be larger than the second gap depth. In an embodiment wherein each ventilation gaps comprises two gap depths of a different size, the ventilation gaps may be tapered such that the ventilation gap has the greatest gap depth proximate an outermost edge of the first and second masks and the gap depth decreases as the ventilation gaps gets closer to a central portion of the first and second masks. In some embodiments, the first gap depth is about 5%, about 10%, about 25%, about 50%, about 75%, or about 90% larger than the second gap depth. The first gap depth can be at least about 5%, at least about 25%, at least about 50%, at least about 75%, or at least about 90% larger than the second gap depth.

In view of the ventilating face masks and systems for mask ventilation discussed above, embodiments of the present disclosure can comprise a method for decreasing the relative humidity on a surface caused by a wearer's breath, the method comprising providing a ventilating face mask. As discussed above, the ventilating face mask can comprise a base layer having a top edge, a bottom edge, and side edges and a ventilation layer, external to the base layer. The ventilation layer comprising side edges and having a top edge attached to the top edge of the base layer and a bottom edge attached to the bottom edge of the base layer. Additionally, as discussed above, the ventilating face mask can comprise one or more ventilation gaps between the side edges of the base layer and the side edges of the ventilation layer. When the ventilating face mask is placed on the wearer's face so as to substantially cover the wearer's nose and mouth, the relative humidity on the surface near the wearer's face can be decreased. The disclosed methods can share some or all of the features discussed above with respect to the ventilating face mask and the mask ventilation systems discussed above.

In view of the ventilating face masks and systems for mask ventilation discussed above, embodiments of the present disclosure can comprise another method for decreasing the relative humidity caused by a wearer's breath and measured about a surface worn close to the wearer's face, the method can comprise providing an expandable ventilating face mask. As discussed above, the expandable ventilating face mask can comprise a base layer having a top edge, a bottom edge, and side edges and a ventilation layer external to the base layer. As discussed above the ventilation layer can comprise side edges and having a top edge attached to the top edge of the base layer and a bottom edge attached to the bottom edge of the base layer. The method can also comprise: expanding the expandable ventilating face mask to form one or more ventilation gaps between the side edges of the base layer and the side edges of the ventilation layer; placing the ventilating face mask on the wearer's face so as to substantially cover the nose and mouth of the wearer; and providing a surface near to the expandable ventilating face mask. Additionally, as discussed above, when the wearer breathes, at least a portion of the wearer's breath can be diverted away from the surface and decreases the relative humidity on the surface. The disclosed methods can share some or all of the features discussed above with respect to the ventilating face mask and the mask ventilation systems discussed above.

### EXAMPLES

### Example 1

### Double-Mask Configuration

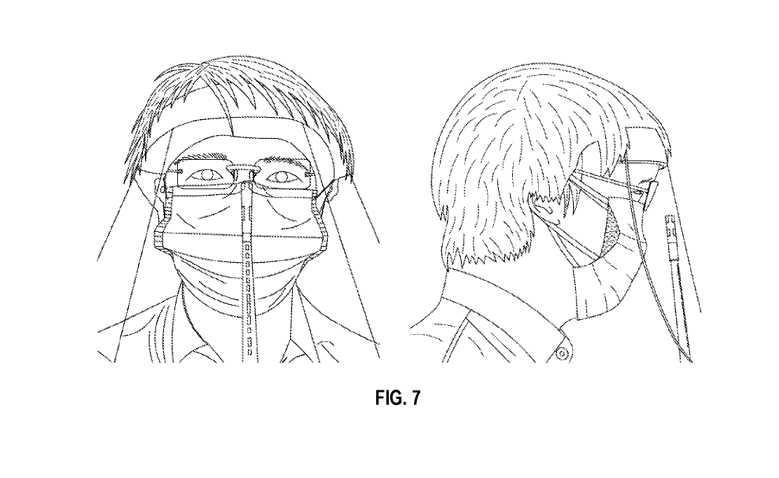

The efficacy of a mask-over-mask configuration in decreasing the relative humidity on a face shield was tested. Medical face masks were obtained from Medline Industries, Inc. The first mask was put on in a normal way, covering the nose, mouth, and part of chin, as illustrated at FIG. 7. The second mask was put on loosely with chin uncovered, as illustrated at FIG. 7. Additionally a face shield was worn over the face mask as illustrated at FIG. 7. An Omega RH30-C digital humidity meter was used to detect the humidity. The probe of the humidity meter was attached to the surface of face shield and about 1 inch away from nose, as shown in FIG. 7. The room temperature was 25° C., and the relative humidity in the room was 50.2%. Relative humidity measurements were taken at 2 minutes.

### Example 2

### Ventilation Layer Configuration

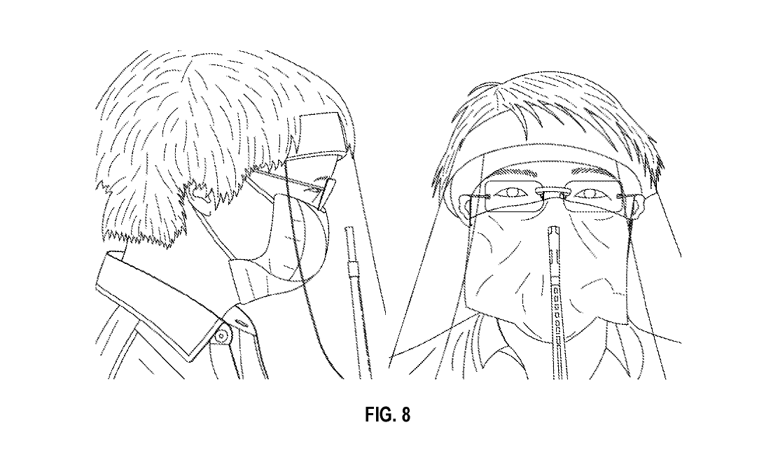

Next, the efficacy of the ventilating face mask in decreasing the relative humidity on a face shield was tested. The ventilating face mask was put on and a face shield was worn over the face mask, as illustrated at FIG. 8. An Omega RH30-C digital humidity meter was used to detect the humidity. The probe of the humidity meter was attached to the surface of face shield and about 1 inch away from nose, as shown in FIG. 8. The room temperature was 25° C., and the relative humidity in the morn was 50.2%. Relative humidity measurements were taken at 2 minutes.

### Results

After two minutes of wearing the mask-over-mask configuration and breathing, the relative humidity on the surface of the face shield was approximately 55.4% (C₂=0.0123 kg/kg dry air). Additionally, no fogging was observed on the face shield. Wearing two medical face masks is easy and quick for a wearer to avoid fogging on the face shield, but it is a temporary approach. After two minutes of wearing the ventilating face mask and breathing, the relative humidity on the surface of face shield was 51.5% (C₂=0.0108 kg/kg dry air). Additionally, no fogging was observed on the face shield. The ventilating face mask provides a more permanent approach to decreasing the relative humidity about a face shield.

The specific configurations, choice of materials, and the size and shape of various elements can be varied according to particular design specifications or constraints requiring a system or method constructed according to the principles of the present disclosure. Such changes are intended to be embraced within the scope of the present disclosure. The presently disclosed embodiments, therefore, are considered in all respects to be illustrative and not restrictive. The patentable scope of certain embodiments of the present disclosure is indicated by the appended claims, rather than the foregoing description, and all changes that come within the meaning and range of equivalents thereof are intended to be embraced therein.

### EMBODIMENTS

Additionally or alternately, the disclosure can include one or more of the following embodiments.

### Embodiment 1

A ventilating face mask comprising: a base layer having a top edge, a bottom edge, and side edges; a ventilation layer, external to the base layer, the ventilation layer comprising side edges and having a top edge attached to the top edge of the base layer and a bottom edge attached to the bottom edge of the base layer; and one or more ventilation gaps between the side edges of the base layer and the side edges of the ventilation layer.

### Embodiment 2

A mask ventilation system comprising: a base layer having side edges; a ventilation layer overlaying the base layer and having side edges; and wherein the side edges of the base layer and side edges of the ventilation layer define one or more ventilation gaps.

### Embodiment 3

A mask ventilation system for decreasing the relative humidity on a surface caused by a wearer's breath, the mask ventilation system comprising: an expandable base layer having a top edge, a bottom edge, and side edges; a ventilation layer external to the expandable base layer, the ventilation layer comprising side edges and having a top edge attached to the top edge of the expandable base layer and a bottom edge attached to the bottom edge of the expandable base layer; and wherein when the expandable base layer is in an expanded state, the side edges of the ventilation layer and the side edges of the expandable base layer define one or more ventilation gaps between the expandable base layer and the ventilation layer for diverting at least a portion of the wearer's breath away from the surface, wherein the diversion decreases the relative humidity on the surface.

### Embodiment 4

A method for decreasing the relative humidity on a surface caused by a wearer's breath, the method comprising: providing a first mask; and layering a second mask over the first mask wherein the second mask is layered loosely such that one or more ventilation gaps form between the first mask and the second mask.

### Embodiment 5

A method for decreasing the relative humidity on a surface caused by a wearer's breath, the method comprising: providing a ventilating face mask comprising a base layer having a top edge, a bottom edge, and side edges; a ventilation layer, external to the base layer, the ventilation layer comprising side edges and having a top edge attached to the top edge of the base layer and a bottom edge attached to the bottom edge of the base layer; and one or more ventilation gaps between the side edges of the base layer and the side edges of the ventilation layer; wherein when the ventilating face mask is placed on the wearer's face so as to substantially cover the wearer's nose and mouth, the relative humidity on the surface near the wearer's face decreases.

### Embodiment 6

A method for decreasing the relative humidity caused by a wearer's breath and measured about a surface worn close to the wearer's face, the method comprising: providing an expandable ventilating face mask comprising a base layer having a top edge, a bottom edge, and side edges; and a ventilation layer, external to the base layer, the ventilation layer comprising side edges and having a top edge attached to the top edge of the base layer and a bottom edge attached to the bottom edge of the base layer; expanding the expandable ventilating face mask to form one or more ventilation gaps between the side edges of the base layer and the side edges of the ventilation layer; placing the ventilating face mask on the wearer's face so as to substantially cover the nose and mouth of the wearer; and providing a surface near to the expandable ventilating face mask; wherein when the wearer breathes, at least a portion of the wearer's breath is diverted away from the surface and decreases the relative humidity on the surface.

### Embodiment 7

The systems or methods of one of the previous embodiments further comprising a medial width and a lateral width.

### Embodiment 8

The systems or methods of one of the previous embodiments further comprising a medial width and a lateral width, wherein the medial width is greater than the lateral width.

### Embodiment 9

The systems or methods of one of the previous embodiments wherein the base layer and the ventilation layer are separated by a first gap depth and a second gap depth.

### Embodiment 10

The systems or methods of one of the previous embodiments wherein the base layer and the ventilation layer are separated by a first gap depth and a second gap depth and the first gap depth is greater than the second gap depth.

### Embodiment 11

The systems or methods of one of the previous embodiments wherein the base layer comprises two or more sub-layers.

### Embodiment 12

The systems or methods of one of the previous embodiments wherein the ventilation layer is composed of a permeable material.

### Embodiment 13

The systems or methods of one of the previous embodiments wherein the relative humidity is measured about the surface when the surface is near the wearer's face.

### Embodiment 14

The systems or methods of one of the previous embodiments wherein the relative humidity is measured about the surface when the surface is near the wearer's face and wherein the relative humidity decreases by at least about 10%, at least about 25%, or at least about 40%.

### Embodiment 15

The systems or methods of one of the previous embodiments wherein the expandable base layer comprises pleating.

### Embodiment 16

The systems or methods of one of the previous embodiments wherein in an unexpanded state the expandable base layer is defined by an unexpanded medial width and wherein in an expanded state the expandable base layer is defined by an expanded medial width.

### Embodiment 17

The systems or methods of one of the previous embodiments wherein in an unexpanded state the expandable base layer is defined by an unexpanded medial width and wherein in an state position the expandable base layer is defined by an expanded medial width and wherein in an expanded state, the expanded medial width is greater than the unexpanded medial width.

### Embodiment 18

The systems or methods of one of the previous embodiments wherein in an unexpanded state, the ventilation layer is substantially flush with the base layer.

### Embodiment 19

The systems or methods of one of the previous embodiments wherein the ventilation layer is expandable.

### Embodiment 20

The systems or methods of one of the previous embodiments wherein the surface comprises a face shield.

### Embodiment 21

The systems or methods of one of the previous embodiments wherein in an expanded state, the base layer and the ventilation layer are separated by a first gap depth and a second gap depth.

### Embodiment 22

The systems or methods of one of the previous embodiments wherein in an expanded state the base layer and the ventilation layer are separated by a first gap depth and a second gap depth and wherein the first gap depth is greater than the second gap depth.

1. A ventilating face mask comprising:
a base layer securable to a user, the base layer comprising a top edge, a bottom edge, and side edges;
a ventilation layer disposed over and covering an external surface of the base layer, the ventilation layer comprising:
side edges, wherein at least a portion of the side edges of the ventilation layer are not attached to the side edges of the base layer;
a top edge attached to the top edge of the base layer; and
a bottom edge attached to the bottom edge of the base layer; and
one or more ventilation gaps comprising a space disposed between the base layer and the ventilation layer, the space defined by the side edges of the base layer and the side edges of the ventilation layer.

2.-3. (canceled)

4. The ventilating face mask of claim 1, wherein the one or more ventilation gaps are defined by a first gap depth and a second gap depth, the first and second gap depths representing a linear distance between the ventilation layer and the base layer.

5. The ventilating face mask of claim 4, wherein the first gap depth is greater than the second gap depth.

6. The ventilating face mask of claim 1, wherein the base layer comprises two or more sub-layers.

7. The ventilating face mask of claim 1, wherein the ventilation layer is composed of a permeable material.

8.-15. (canceled)

16. A mask ventilation system for decreasing the relative humidity proximate a surface of the mask ventilation system caused by a wearer's breath, the mask ventilation system comprising:
an expandable base layer comprising a top edge, a bottom edge, and side edges and configured to transition from an unexpanded state to an expanded state;
a ventilation layer disposed over and covering an external surface of the expandable base layer, the ventilation layer comprising:
side edges, wherein at least a portion of the side edges of the ventilation layer are not attached to the side edges of the expandable base layer;
a top edge attached to the top edge of the expandable base layer; and
a bottom edge attached to the bottom edge of the expandable base layer;
wherein when the expandable base layer is in an expanded state, the side edges of the ventilation layer and the side edges of the expandable base layer define one or more ventilation gaps between the expandable base layer and the ventilation layer, the one or more ventilation gaps defined by a gap depth and a gap length and configured to divert at least a portion of the wearer's breath away from a surface of the mask ventilation system when worn proximate the face of the wearer to decrease the relative humidity on the surface of the mask ventilation system.

17. (canceled)

18. The mask ventilation system of claim 16, wherein the relative humidity on the surface of the mask ventilation system decreases by at least 25% due to the one or more ventilation gaps, when the mask ventilation system is worn proximate the face of the wearer.

19. The mask ventilation system of claim 16, wherein the relative humidity on the surface of the mask ventilation system decreases by at least 10% due to the one or more ventilation gaps, when the mask ventilation system is worn proximate the face of the wearer.

20. The mask ventilation system of claim 16, wherein the relative humidity on the surface of the mask ventilation system decreases by at least 40% due to the one or more ventilation gaps, when the mask ventilation system is worn proximate the face of the wearer.

21. The mask ventilation system of claim 16, wherein the expandable base layer comprises pleating.

22. The mask ventilation system of claim 16, wherein in the unexpanded state the expandable base layer is defined by an unexpanded medial width and wherein in the expanded state the expandable base layer is defined by an expanded medial width.

23. The mask ventilation system of claim 22, wherein in the expanded state, the expanded medial width is greater than the unexpanded medial width.

24. The mask ventilation system of claim 16, wherein in the unexpanded state, the ventilation layer is substantially flush with the base layer.

25. The mask ventilation system of claim 16, wherein the ventilation layer is expandable.

26. The mask ventilation system of claim 16, wherein the ventilation layer comprises pleating.

27. The mask ventilation system of claim 16 further comprising a face shield disposed proximate an external surface of the mask ventilation system.

28. The mask ventilation system of claim 16, wherein in an expanded state, the ventilation gaps are defined by a first gap depth and a second gap depth.

29. The mask ventilation system of claim 28, wherein the first gap depth is greater than the second gap depth.

30.-47. (canceled)

48. A method for decreasing the relative humidity caused by a wearer's breath and measured about a surface worn close to the wearer's face, the method comprising:
providing an expandable ventilating face mask comprising:
a base layer having a top edge, a bottom edge, and side edges, the base layer securable to the wearer; and
a ventilation layer, external to the base layer, the ventilation layer comprising side edges and having a top edge attached to the top edge of the base layer and a bottom edge attached to the bottom edge of the base layer;
expanding the expandable ventilating face mask to form one or more ventilation gaps between the side edges of the base layer and the side edges of the ventilation layer;
placing the ventilating face mask on the wearer's face so as to cover the nose and mouth of the wearer; and
providing a surface near to the expandable ventilating face mask;
wherein when the wearer breathes, at least a portion of the wearer's breath is diverted away from the surface and decreases the relative humidity on the surface.

49. The method of claim 48, wherein the relative humidity on the surface decreases by at least 25% due to the one or more ventilation gaps, when the mask ventilation system is worn proximate the face of the wearer.

50.-63. (canceled)
